(19) United States
(12) Patent Application Publication
(10) Pub. No.: US 2013/0130131 A1
(43) Pub. Date: May 23, 2013

(54) RECHARGEABLE LITHIUM AIR BATTERY HAVING ORGANOSILICON-CONTAINING ELECTROLYTE

(71) Applicant: Johnson IP Holding, LLC, Atlanta, GA (US)

(72) Inventors: Lonnie G. JOHNSON, Atlanta, GA (US); Davorin BABIC, Marietta, GA (US); Tedric D. CAMPBELL, Lithia Springs, GA (US); John Scott FLANAGAN, Chamblee, GA (US)

(73) Assignee: JOHNSON IP HOLDING, LLC, Atlanta, GA (US)

(21) Appl. No.: 13/675,579

(22) Filed: Nov. 13, 2012

Related U.S. Application Data
(63) Continuation-in-part of application No. 12/752,754, filed on Apr. 1, 2010.
Application No. 12/752,754 is a continuation-in-part of application No. 11/843,814, filed on Aug. 23, 2007.
(60) Provisional application No. 61/558,553, filed on Nov. 11, 2011.

(51) Int. Cl. H01M 8/22

(52) U.S. Cl. CPC H01M 8/22
USPC 429/403; 429/532; 429/526; 429/524

(57) ABSTRACT

A rechargeable lithium air battery comprises a non-aqueous electrolyte disposed between a spaced-apart pair of a lithium anode and an air cathode. The electrolyte includes including a lithium salt and an additive containing an alkylene group or a lithium salt and an organosilicon compound. The alkylene additive may be alkylene carbonate, alkylene siloxane, or a combination of alkylene carbonate and alkylene siloxane. The alkylene carbonate may be vinylene carbonate, butylene carbonate, or a combination of vinylene carbonate and butylene carbonate. The alkylene siloxane may be a polymerizable silane such as triacetoxyvinylsilane. In preferred embodiments, the organosilicon compound is a silane containing polyethyleneoxide side chain(s).

### CROSS-REFERENCE TO RELATED APPLICATIONS

This application is a continuation-in-part of co-pending U.S. patent application Ser. No. 12/752,754, filed Apr. 1, 2010, which is a continuation-in-part of U.S. patent application Ser. No. 11/843,814 filed Aug. 23, 2007, and further claims priority to U.S. patent application No. 61/558,553, filed Nov. 11, 2011, the entirety of which are incorporated herein by reference.

### BACKGROUND OF THE INVENTION

A battery cell is a particularly useful article that provides stored electrical energy which can be used to energize a multitude of devices requiring an electrical power source. A battery cell, which is often referred to, somewhat inaccurately, in an abbreviated form as a “battery,” is an electrochemical apparatus typically formed of at least one electrolyte (also referred to as an “electrolytic conductor”) disposed between a pair of spaced apart electrodes. The electrodes and electrolyte are the reactants for a chemical reaction that causes an electric current to flow between the electrodes when the electrode ends that are not in contact with the electrolyte are connected to one another through an object or device (generally referred to as the “load”) to be powered. The flow of electrons through the free ends of the electrodes is accompanied and caused by the creation and flow of ions in and through the electrolyte under a reaction potential between the electrodes.

In a non-rechargeable battery cell, the chemical reaction that produces the flow of electric current also causes one or more of the reactants to be consumed or degraded over time as the cell discharges, thereby depleting the cell. In contrast, in a rechargeable battery cell, after the cell has partially or fully discharged its electrical potential, the chemical reaction may be reversed by applying an electric current to the cell that causes electrons to flow in an opposite direction between the electrodes and an associated flow of ions. Thus, it can be appreciated that rechargeable battery cells are extremely useful as a source of electrical power that can be replenished.

A problem in utilizing rechargeable batteries is that it is often difficult to return the reactants to their original, pre-use state, that is, the pristine or ideal (or as close as possible) condition that the reactants are in before the cell is used. This problem relates to specific problems associated with returning each individual reactant to its original state.

Lithium air batteries are attractive batteries because they provide high energy density from easily-obtainable and inexpensive electrode reactant materials, namely, lithium and air. In a lithium air battery, lithium serves as the anode and the cathode is formed of a light-weight, inexpensive substrate that is capable of supporting a catalyst for facilitating oxygen's role as a reactant.

A problem with rechargeable lithium air batteries is that they are particularly difficult to recharge multiple times due to the characteristics of lithium. Specifically, it is often difficult to return the lithium anode to its pre-discharge condition because of imperfections formed on the surface of the anode during the discharge-recharge cycling. Imperfection problems include a roughening of the surface of the anode and the formation of pores in the anode. Another serious imperfection problem is that the surface of the lithium anode that is in contact with the electrolyte may be degraded by the formation of dendrites. Dendrites are thin protuberances that can grow upon and outwardly of a surface of an electrode during recharging of the cell. Recharging causes a re-plating of the lithium anode. Not only do dendrites inhibit proper plating or re-plating of the electrode, but also, one or more branches of dendrites may grow long enough so as to extend through the electrolyte between the anode and cathode and thereby provide a direct connection that can electrically short circuit the cell. An electrical short is undesirable in and of itself but, in addition, the current passing through an electrical short may cause the temperature through the electrolyte to increase to a point wherein the electrolyte is no longer effective and/or the electrolyte and/or the cell itself may ignite. Thus, known lithium air batteries have a very limited useful life. It can thus be appreciated that it would be useful to develop a rechargeable lithium air battery cell that can be discharged and recharged effectively many times.

A concern in recharging a rechargeable battery is how much electrical energy will be required to restore the battery to its pre-discharged state and potential. This level of electrical is typically greater than the electrical energy initially provided by the battery. However, it is desirable that the electrical energy required to recharge a rechargeable battery be minimized so as to reduce the cost of operation and to prevent damage to the battery. Thus, it can be appreciated that it would be useful to develop a rechargeable lithium air battery in which the voltage level and amount of energy required to recharge the battery are minimized. The excess energy required during recharge is associated with a difficulty in reversing the reactions that take place in an air cathode. Reactions in the cathode are plagued with parasitic reactions involving the electrolyte. These reactions can consume the electrolyte and cause degradations in performance. Therefore, a more stable electrolyte is needed.

Most battery systems developed to date are based on aqueous-based alkaline electrolytes. A popular example is the zinc/oxygen battery that is in commercial use for hearing aids. Electric Fuel Corp. produces primary zinc air batteries for cellular phone applications. Electrically rechargeable zinc air batteries use bifunctional oxygen electrodes so that both the charge and discharge processes take place within the battery structure. AER Energy Resources, Inc. (Atlanta, Ga.) designed an electrically rechargeable zinc air cell; however, the cyclability of this battery is too low to satisfy the requirements of many commercial applications.

In recent years, there has been a renewed interest in the development of lithium oxygen batteries. To overcome water corrosion problems, non-aqueous electrolytes typically used in lithium and lithium ion batteries have been utilized. For example, U.S. Pat. No. 5,510,209 describes a lithium oxygen battery based on an organic electrolyte using carbon powder as an air electrode and cobalt phthalocyanine as a catalyst. The battery was shown to have an open-circuit potential of approximately 3V and an operating voltage between 2.0 to 2.8V.

Although the '209 patent suggests that the lithium/oxygen batteries were rechargeable, no more than two complete cycles were reported. On the other hand, the formation of Li₂O₂ in the discharged air electrode was observed by chemical titration analysis, but the disappearance of Li₂O₂ in the recharged (not original) air electrode was not shown. Therefore, the rechargeability of this lithium oxygen battery is not conclusive.

The discharge mechanism of a lithium oxygen battery is primarily the deposition of Li₂O₂ in the carbon-based air electrode. Since the reduction of O₂ to O²⁻ occurs only in the presence of a catalyst, the product is often the peroxide, O₂²⁻. The reactions of lithium with oxygen are:

2Li+O₂→Li₂O₂ E°=3.10 V

4Li+O₂→2Li₂O E°=2.91V

Before completely forming peroxide, an oxygen molecule can reduce to form a superoxide radical which links with one lithium cation, forming lithium superoxide. This intermediate can precipitate within the cathode, forming peroxide, which may support ongoing cycling or attack carbonate based solvents through nucleophilic mechanisms, thus choking off cycling. Lithium superoxide is not a stable compound and will convert to peroxide, but this in part depends upon the stability of the solvent. The superoxide reaction is expected to proceed as follows:

O₂+Li⁺+e⁻→LiO₂

2LiO₂→Li₂O₂+O₂

There remains a need in the art for further improvements in battery structure to maximize the potential of rechargeable lithium air and lithium oxygen batteries.

### BRIEF SUMMARY OF THE INVENTION

This invention relates to rechargeable battery cells, and more particularly, the invention relates to electrolytes for rechargeable, lithium air battery cells.

According to the present invention, a rechargeable lithium air battery comprises a non-aqueous, organic-solvent-based electrolyte including a lithium salt and an additive containing an alkylene group, disposed between a spaced apart pair of an anode and an air cathode.

In one embodiment of the invention, the alkylene additive is selected from the group consisting of alkylene carbonate, alkylene siloxane, and a combination of alkylene carbonate and alkylene siloxane.

In an aspect of this embodiment, alkylene carbonate is selected from the group consisting of vinylene carbonate, butylene carbonate, and a combination of vinylene carbonate and butylene carbonate.

In another aspect of this embodiment, alkylene siloxane is a polymerizable silane. And in a further aspect, the polymerizable silane is triacetoxyvinylsilane.

In another embodiment of the invention, a separator is disposed between the air cathode and the anode and is infused with the non-aqueous, organic-solvent-based electrolyte including a lithium salt and an alkylene additive.

The invention also relates to a rechargeable lithium air battery comprising a lithium based anode, an air cathode, and a non-aqueous electrolyte, wherein the electrolyte comprises a lithium salt and at least one organosilicon compound, and wherein the anode and the cathode are spaced apart from one another and electrochemically coupled to one another by the electrolyte.

Additionally, a cathode for a rechargeable lithium air battery comprises a carbon-based, porous electrode and a non-aqueous electrolyte comprising a lithium salt and at least one organosilicon compound.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is a schematic representation of a rechargeable battery cell according to an embodiment of the present invention.

FIG. 2 is a schematic representation of a rechargeable battery cell according to a second embodiment of the present invention.

FIG. 3 is a schematic representation of a cell assembly having a double-cell structure comprising a single anode flanked on both sides by a cathode according to an embodiment the present invention.

FIG. 4 is a schematic representation of a step in the construction of a sealed cell according to an embodiment of the present invention.

FIG. 5 is a schematic representation of another step in the construction of a sealed cell according to an embodiment of the present invention.

FIG. 6 is a schematic representation of a further step in the construction of a sealed cell according to an embodiment of the present invention.

FIG. 7 is a box-plot graph comparing performance characteristics (Rest Voltage Before Cycling) of inventive and comparative cells.

FIG. 8 is a box-plot graph comparing performance characteristics (Discharge Voltage During Second Cycle) of inventive and comparative cells.

FIG. 9 is a box-plot graph comparing performance characteristics (Charge Voltage During Second Cycle) of inventive and comparative cells.

FIG. 10 shows cycling data for a comparative lithium-O₂ cell with PC/glyme solvent.

FIG. 11 shows cycling data for a Lithium/Oxygen cell with silane electrolyte.

### DETAILED DESCRIPTION OF THE INVENTION

Embodiments of the present invention are described herein. The disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, at least some specific structural and functional details disclosed herein are not to be interpreted as limiting, but merely as a basis for the claims and as a representative basis for teaching one skilled in the art to variously employ the present invention.

### Overview

As an overview, the invention teaches a first electrolyte for a rechargeable battery that has a lithium anode and an air cathode, which improved electrolyte helps to increase the useful life and effectiveness of the battery. This electrolyte according to the invention also optimizes (lowers) the level of charge voltage required by the battery during recharging, thereby further increasing the usefulness of the battery. The electrolyte is also stable in the presence of the superoxide radical.

Non-aqueous electrolytes are often used with lithium cells to avoid undesirable reactions between lithium and water-based electrolytes. However, in a cell, a film will typically form on a lithium electrode immersed in a non-aqueous electrolyte. These films form when the lithium metal immersed in the non-aqueous liquid electrolyte generally reacts with the electrolyte solvent, the electrolyte salt, and trace impurities or dissolved gases to form the film. Rather than leaving the nature of the surface film that forms to chance, in one embodiment, the invention modifies the film by introducing additives to the electrolyte solution. These additives are tailored to react with the electrode surfaces and form a surface stabilizing film that is conducive to lithium cycling. This electrolyte of the invention changes the chemical composition of the film such that it adopts characteristics that inhibit the growth of dendrites on the lithium electrode. The invention thus converts the natural presence of the film to a beneficial use in fighting dendrite growth. To convert the film to a desirable composition, the invention uses as additives a class of organic compounds that are capable of being dissolved in the electrolyte solution and capable of polymerizing when placed in contact with lithium metal.

A second electrolyte according to the invention contains an organosilicon compound. These compounds have been found to improve the reversibility of batteries. Silicon-based electrolytes are advantageous due to high conductivity, safety, and favorable electrochemical and chemical properties. The premise behind organosilicon based electrolytes is that they are not susceptible to nucleophilic attack, but maintain properties needed for lithium air cycling. Thus, silicon-containing electrolytes represent a growing area of interest as a means for improving the safety of lithium air batteries.

As a further aspect of this overview and introduction, it is to be noted that the air cathode that is utilized in the invention comprises a porous substrate which supports a material that serves as a catalyst to facilitate oxygen's role in the electrochemical reaction that produces energy. In a lithium air battery, oxygen is the cathode reactant for the overall electrochemical reaction that creates electricity. Oxygen is placed in condition for reacting at the substrate that forms the cathode support member. The cathode may employ a catalyst that facilitates oxygen's participation in the electrochemical reaction. The oxygen may be in an isolated (or pure state), or the cathode may use oxygen that is present in ambient air. The oxygen in ambient air is a natural component of air. Hence, the use of the term “air battery” or “lithium air battery.” For the purposes of this disclosure, the term “lithium air battery” may also be understood to encompass “lithium oxygen batteries.” In both systems, lithium reacts with oxygen, forming Li₂O or Li₂O₂. The distinction between lithium air and lithium-oxygen batteries is the type of oxygen source that is used: oxygen from a tank or oxygen from air. The electrolytes according to the invention are appropriate for both types of systems.

### Invention Described in Detail

Although the term “battery” technically may more properly define a combination of two or more cells, it has come to be used popularly to refer to a single cell. Thus the term battery by itself is sometimes used herein for convenience of explanation to refer to what is actually a single cell. The teachings herein that are applicable to a single cell are applicable equally to each cell of a battery containing multiple cells.

Referring now to the drawings, wherein like numerals indicate like elements throughout the several views, the drawings illustrate certain of the various aspects of exemplary embodiments.

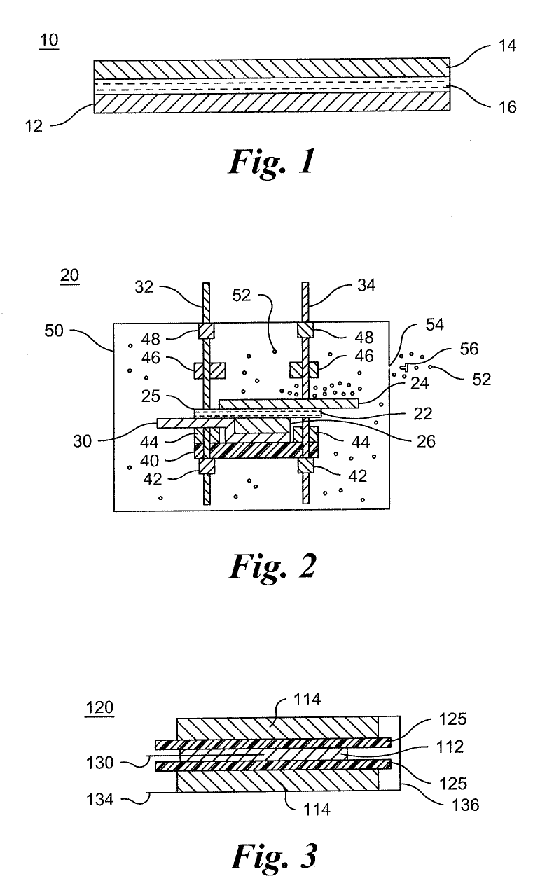

Referring first to FIG. 1, therein is illustrated a schematic representation of a rechargeable battery cell 10 according to an embodiment of the invention. A non-aqueous electrolyte 16 is disposed between a spaced-apart pair of a lithium anode 12 and an air cathode 14. The electrolyte 16 includes a lithium salt and further includes an additive comprising an alkylene compound or includes an organosilicon compound according to the invention, as described in more detail below.

Referring now to FIG. 2, therein is illustrated a schematic representation of a rechargeable battery cell 20 according to a second embodiment of the present invention. In this embodiment, a separator 25 is disposed between and separates a lithium anode 22 and an air cathode 24. The separator 25 is infused with a non-aqueous electrolyte 26. The electrolyte 26 includes a lithium salt and further includes an additive comprising an alkylene compound or includes an organosilicon compound according to the invention, as described in more detail below. The lithium anode 22 adjoins an anode current-collector 30. The anode current-collector 30 may be formed of copper metal or a copper alloy.

An anode current-collector rod 32 is disposed in contact with the anode current-collector 30 and provides an anode connecting point for the cell 20. The anode current-connector rod 32 may be formed of a copper-based material such as copper metal or a copper alloy. A cathode current-connector rod 34 is disposed in contact with the air cathode 24 and provides a cathode connecting point for the cell 20. The cathode current-connector rod 34 may be formed of an aluminum material, such as aluminum metal or an aluminum alloy (aluminum fused with zinc or copper, for example), or may be carbon mesh or an alternative carbon material. The above structures may be supported by a base 40 of rigid, non-reactive, non-electrically conductive material, such as the polymer sold in block form under the brand name Teflon®.

All of the various components described above in the second embodiment of the rechargeable cell 20 may be secured in a housing 50 forming a container. The components may be secured together and to the housing 50 by various securing mechanisms such as nuts 42, 44 that help secure the lower ends of the current-collector rods 32, 34 to the base 40 and nuts 48 that help secure the upper ends of the current-collector rods 32, 34 to the housing. Spacer elements 46 press the electrode stack together while allowing oxygen to reach the cathode 24. The anode current-collector rod 32 extends through and helps secure the position of the separator 25 and the anode current-collector 30 while the cathode current-collector rod 34 extends though and helps secure the position of the separator 25 and air cathode 24. The anode 22 is secured at least in part by being sandwiched between the separator 25 and anode current-connector 30. The housing 50 may contain a quantity of oxygen or air 52 for reaction with the air cathode 24. The housing 50 may have an orifice or aperture 54 through which oxygen or ambient air 52 is introduced into the interior of the housing 50. A removable orifice cover 56 may be used to seal the orifice 54 until injection of oxygen or air is desired.

In either the first or second embodiment described above, the lithium anode 12, 22 is formed of lithium metal, a lithium-metal based alloy, a lithium-intercalation compound, or lithium titanate (Li₂TiO₃). As used herein, the term “lithium-intercalation compound” means those substances having a layered structure that is suitable for receiving and storing lithium compounds for later use (such as in a reaction). Thus, these materials may also be considered “lithium-storage materials.” These lithium-intercalation, or lithium-intercalating compounds, are typically types of carbon. Lithium titanate functions similarly to a lithium-loaded intercalation compound when used as an anode material in a battery cell.

The air cathode 14, 24, described in more detail below, is predominantly a porous substrate, and may be infused with an oxygen-reduction catalyst to facilitate the oxygen reaction at the air cathode. Suitable oxygen-reduction catalysts comprise at least one of electrolytic manganese (IV) dioxide, ruthenium (IV) oxide, copper (II) oxide, copper (II) hydroxide, iron (II) oxide, iron (II,III) oxide, cobalt (II,III) oxide, nickel (II) oxide, silver, platinum and iridium.

The separator 25 is preferably made of a non-conductive polymer. The non-conductive polymer material may be porous, for example, in the nature of a sponge, so as to effectively hold the electrolyte described herein.

An embodiment of a cell constructed in accordance with the teachings of the invention is sealed in an enclosure wherein oxygen or air is injected to a predetermined pressure. Suitable operating pressure is in the range from about 0.1 atm to about 100 atm, and an optimum range is from about 0.5 atm to about 20 atm.

Referring to FIG. 3, a cell assembly 120 is comprised of a lithium metal, lithium alloy, or lithium intercalation anode 112 that is sandwiched between two separators 125. The anode terminal 130 is connected to the specific anode. The separators 125 may be composed of a conductive or non-conductive polymer and may be porous or nonporous. Air electrodes 114 are adhered to the separator via chemical bonding (such as surface modifications or doping) and/or physical bonding (such as by using pressure or gluing agents). The air electrode 114 is comprised of a carbon component, a polymer binder component, and a catalyst component. Specific additives such as lithium peroxide may or may not be included. The cathodes are connected via electrical structure 136. The cathode terminal 134 is either connected to the cathode via chemical or physical processes or may be embedded within the cathode.

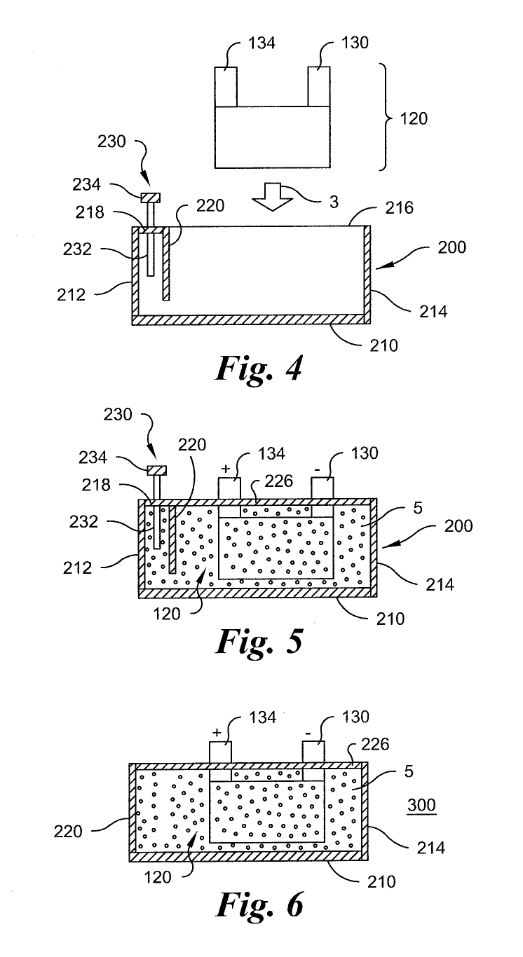

Reference is now made generally to FIGS. 4, 5 and 6, which are schematic representations of a cell assembly 120 placed within a bag container 200 to form a completed, sealed cell 300 in accordance with the present invention. First, reference is made specifically to FIG. 4, in which a bag 200 made of multilayer polymer and metal laminate is pre-sealed completely on three sides and has a fourth side that is partially pre-sealed. A suitable polymer is polypropylene, such as the thin-sheet polypropylene product manufactured and sold by E. I. du Pont de Nemours and Company under the trademark DuPont™ Surlyn®. In FIG. 4, sealing is indicated by spaced-apart double lines with cross-hatching which double lines extend across the lower-most edge 210 and parallel side edges 212, 214. The fourth side, which is an upper-most edge in the orientation of FIG. 4, has an opening 216 along a portion of its length adjacent a sealed portion 218 of the upper-most edge. The partially-sealed bag essentially forms a pouch that is open at the top. An inner seal 220 extends parallel to one sealed side edge 212 for a substantial distance. The inner seal 220, parallel side edge 212 and partial seal 218 of the upper-most edge form a substantially U-shaped cavity. The upper-edge partial seal 218 seals a shaft 232 of a hypodermic needle 230 in the U-shaped cavity. The hypodermic needle 230 has an uppermost end 234 that is adapted for receiving an instrument for injection of a gas. The uppermost end 234 is particularly adapted for receiving a syringe (not shown) through which oxygen or air (that contains oxygen) is infused into the hag 200. Prior to placement of the needle 230 in the bag 200, the upper end 234 of the needle 230 may be sealed with epoxy or by other known means to prevent moisture from being introduced into the bag (because of the undesirable interaction of water with lithium). After ensuring that the cathode is not peeling from the separator, the cell assembly 120 is soaked in the electrolyte for at least 5 to 10 minutes, and then inserted (as shown by the direction arrow 3) into the preassembled pouch/partially sealed bag 200 with the anode current-collector tab 130 and the cathode current-collector tab 134 extending outwardly of the upper edge of the bag 200.

Referring now to FIG. 5, after the cell assembly 120 has been inserted, the bag container 200 is sealed across the current-collector mesh tabs, thus forming the completed upper-most seal 226. The fully-sealed bag 200 is then removed from the glove box and oxygen or air is injected into the bag. For example, a syringe (not shown) may be connected to the upper end 234 of the needle 230 so as to penetrate the sealed (epoxy or otherwise) opening and inject oxygen or air 5 into the bag 220.

Referring now to FIG. 6, after oxygen 5 has been injected into the bag 200, the partial inner seal 220 is fully extended between the upper-most sealed edge 226 and lower-most sealed edge 210 of the bag 200, thus segregating the needle shaft 232. Sealing may be accomplished through use of a heat-sealing device commonly known as an impulse sealer. The needle-containing portion of the bag then may be removed by simple cutting, trimming, or other conventional means leaving a completed, sealed cell 300 in accordance with the teachings of the invention.

### Electrolytes Containing Alkylene Additive

In one embodiment, the invention modifies the lithium film that forms on a lithium electrode to produce a film that is conducive to lithium cycling (that is, discharging and recharging the cell). The film is modified by providing an electrolyte containing one or more additives that react with the electrode surfaces to form a surface-stabilizing film that is conducive to cycling.

An electrolyte for a battery cell typically comprises a salt dissolved in a solvent, often water. The invention employs a non-aqueous, organic-solvent-based electrolyte including a lithium salt and an alkylene additive. A non-aqueous electrolyte is used to avoid the damaging effects that water has upon lithium.

A suitable lithium salt for producing the electrolyte comprises at least one of lithium hexafluorophosphate, lithium tetrafluoroborate, lithium hexafluoroarsenate, lithium perchlorate, lithium bis(trifluorosulfonyl)imide, lithium bis(perfluoroethylsulfonyl)imide, lithium triflate, lithium bis(oxalato)borate, lithium tris(pentafluoroethyl)trifluorophosphate, lithium bromide, and lithium iodide. For convenience, the following table provides (molecular) chemical formulas for these salts:

Lithium Salts Suitable For Use In Producing An Electrolyte

| Molecular | Common Name or Alternative Name(s) or |
|---|---|
| Formula | Acronym(s) |
| LiPF₆ | lithium hexafluorophosphate |
| LiBF₄ | lithium tetrafluoroborate |
| LiAsF₆ | lithium hexafluoroarsenate |
| LiClO₄ | lithium perchlorate |
| LiB(C₂O₄)₂ | lithium bis(oxalato)borate; [LiBOB] |
| LiN(SO₂CF₃)₂ | lithium bis(trifluorosulfonyl) imide; lithium |
| | trifluoromethanesulfonimide; lithium |
| | trifluoromethanesulphonylimide; lithium |
| | bis(trifluoromethane sulfone)imide; lithium |
| | bistrifluoromethanesulfonamide; [LiTFSI] |
| LiN(SO₂CF₂CF₃)₂ | lithium bis(perfluoroethylsulfonyl) imide |
| CF₃SO₃Li | lithium triflate; primary chemical name— |
| | lithium trifluoromethanesulfonate; also |
| | known as trifluoromethanesulfonic acid |
| | lithium salt |
| LiBr | lithium bromide |
| LiI | lithium iodide |
| Li(C₂F₅)₃PF₃ | lithium tris(pentafluoroethyl) |
| | trifluorophosphate |

To form the electrolyte solution, one or more of the above salts is dissolved in a solvent. Salt concentrations may range from 0.01-5 molar, but the preferred range is 0.5-1.5 molar. Examples of suitable solvents include two solvent mixtures: 1:2 (w:w) propylene carbonate and tetraglyme (PC:Tetraglyme) (“tetraglyme” is an amalgam of “tetraethylene glycol dimethyl ether”) and 1:2 (w:w) propylene carbonate and 1,2-dimethoxyethane (PC:DME).

Other suitable electrolyte solutions that may be employed in the invention are electrolyte solutions that are typically used for lithium-ion batteries. Such electrolyte solutions contain solvents that are based upon carbonates, esters, ethers, amines, amides, nitriles and sulfones. Such solvents include propylene carbonate, ethylene carbonate, dimethyl carbonate, diethyl carbonate, ethylene carbonate, 1,2-dimethoxyethane, diethyl carbonate, ethyl methyl carbonate, gamma-butyrolactone, sulfolane, 1,3-dioxolane, tetrahydrofuran, dimethoxyethane, diglyme, tetraglyme, diethyl ether, 2-methyl tetrahydrofuran, tetrahydropyran, pyridine, n-methyl pyrrolidone, dimethyl sulfone, ethyl methyl sulfone, ethyl acetate, dimethyl formamide, dimethyl sulfoxide, acetonitrile, and methyl formate.

Suitable proportions of alkylene additives range from less than 1% up to 10% by weight based on the weight of the electrolyte solution.

The additive for the non-aqueous, organic-solvent-based electrolyte comprises an alkylene compound. Suitable alkylene compounds are capable of dissolving in the electrolyte solution and also capable of polymerizing when coming into contact with lithium metal. Suitable alkylene compounds are alkylene carbonates, alkylene siloxanes, and combinations of alkylene carbonate and alkylene siloxane.

Suitable alkylene carbonates are vinylene carbonate, butylene carbonate, and a combination of vinylene carbonate and butylene carbonate. Vinylene carbonate, which for convenience is sometimes herein abbreviated as “VC,” has the following structural formula:

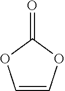

A suitable alkylene siloxane is a polymerizable silane such as triacetoxyvinylsilane. Triacetoxyvinylsilane, which for convenience is sometimes herein abbreviated as “VS,” has the following structural formula:

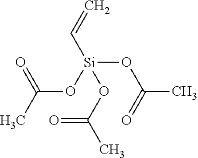

### Organosilicon-Containing Electrolyte

In a second embodiment, the electrolyte used in the lithium air cell contains at least one organosilicon compound. Such compounds have been found to improve the reversibility of batteries. Silicon-based electrolytes are advantageous due to high conductivity, safety, and favorable electrochemical and chemical properties. Thus, silicon-containing electrolytes represent a growing area of interest as a means for improving the safety of lithium air batteries.

Preferably, the organosilicon compound is a silane compound or a siloxane compound. The term “siloxane” technically describes a class of compounds containing alternate silicon and oxygen atoms with the silicon atoms bound to hydrogen atoms or organic groups. Silanes are compounds containing silicon-carbon bonds, analogous to alkanes. However, the terms “silane” and “siloxane” are often used interchangeably and incorrectly in the literature, and, for the purposes of this disclosure, these terms are not meant to be limited to the literal definitions thereof.

Preferred organosilicon compounds for use in the electrolyte according to the invention are those containing polyethylene oxide (PEO) side chains. Most preferred organosilicon compounds are trimethylsilane compounds having Formula (1) below, in which “n” is an integer representing the number of ethylene oxide units in the molecule and may range from 1 to about 20. Other preferred compounds are silanes containing more than one PEO side chain on the central silicon atom, including silanes having two, three, and four PEO side chains on the central silicon atom. Substituents on the silicon which are not PEO side chains may be hydrogen, substituted or unsubstituted alkyl groups having at least one carbon atom (methyl), or other substituted or unsubstituted organic groups. It is also within the scope of the invention for the electrolyte to contain more than one organosilicon compound.

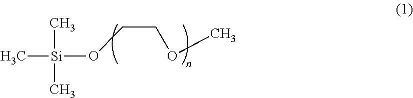

The electrolyte further contains a salt, preferably a lithium salt as previously described. Preferred salts are LiBOB and LiTFSI. In a preferred embodiment, the electrolyte contains only the organosilicon compound with salt dissolved therein, preferably at a concentration of about 1 molar. No additional solvent is present in the electrolyte in a preferred embodiment. The electrolyte may contain additional organosilicon compound(s) and/or task specific additives in amounts of up to about 10 weight percent based on the total weight of the electrolyte. Such additives are known in the art or may be determined by routine experimentation.

### Anode, Air Cathode, and Separator: General Construction and Materials

Suitable anode materials include, but are not limited to lithium metal, lithium-metal-based alloys (for example, Li—Al, Li—Sn, and Li—Si), lithium-intercalating compounds that are typically used in lithium ion batteries (such as but not limited to graphite, mesocarbon microbead (MCMB) carbon, and soft carbon), and lithium titanate, which is also frequently used in lithium ion batteries.

The invention also encompasses cathode materials and air cathodes, such as for lithium air and/or lithium oxygen batteries. An air electrode according to the invention contains a carbon-based porous electrode (containing cathode active material, binder, and optionally oxidation reduction catalyst) and the non-aqueous electrolyte containing a lithium salt and an organosilicon compound or an alkylene additive according to the invention. Exemplary and preferred lithium salts, organosilicon compounds, and alkylene additives have been previously described.

The air cathode may be infused with or contain an oxidation reduction catalyst to facilitate oxygen reduction at the air cathode. Suitable oxidation reduction catalysts comprise at least one of electrolytic manganese (IV) dioxide, ruthenium (IV) oxide, copper (II) oxide, copper (II) hydroxide, iron (II) oxide, iron (II,III) oxide, cobalt (II,III) oxide, nickel (II) oxide, silver, platinum and iridium.

An exemplary reversible air cathode according to the invention initially contains about 14% lithium peroxide (Li₂O₂); however, the cell will operate effectively if the air cathode contains from about 0.5% to about 50% Li₂O₂. The addition of lithium peroxide to the air cathode helps facilitate the preservation of initial porosity of the air cathode. The lithium peroxide initially attaches to the porous structure of the substrate and then, when the cell is charged, the lithium peroxide participates in a chemical reaction that causes it to vacate the porous substrate, thereby increasing the porosity of the substrate. The lithium peroxide thus helps preserve the intended initial porosity by essentially serving as a placeholder for open space in the air cathode.

Battery capacity increases with increasing proportion of active carbon and porosity. Suitable porous cathode active materials include but are not limited to Calgon™ carbon (activated carbon), carbon black (such as Timcal Super P Li carbon), metal powders (such as Ni powder), activated carbon cloths, porous carbon fiber papers, and metal foams.

Suitable binders for the carbon electrodes include, but are not limited to, carboxymethyl cellulose (CMC), polyimide (PI), polyvinylidene fluoride (PVDF) fluoropolymer resin, polytetrafluoroethylene (PTFE) fluoropolymer resin, Teflon® AF amorphous fluoropolymers (Teflon® is a registered trademark of E. I. du Pont de Nemours and Company), and fluorinated ethylene propylene (FEP).

The separator included in the battery according to the invention is preferably made of a non-conductive polymer. The non-conductive polymer material may be porous, for example, in the nature of a sponge, so as to effectively hold the electrolyte described herein. Appropriate separator materials are well known in the art and need not be described. Thus, a battery according to the invention contains, in a preferred embodiment, electrolyte between the cathode and the anode, as well as electrolyte contained in the separator and in the air cathode.

The term “air” as used herein is not intended to be limited to ambient air, but includes other combinations of gases containing oxygen as well as pure oxygen. As previously noted herein, oxygen is a reactant in the electrochemical process of the invention and references to the term “air” are meant to imply that it is the oxygen in air that is applicable. Thus this broad definition of “air” applies to all uses of that term herein, including but not limited to lithium air, air battery, air cathode, and air supply.

It is to be understood that the described invention may include a battery that has not yet formed the active material of the anode or a battery which includes a preformed anode containing active material. When the battery does not yet include active anode material, the active anode material is formed upon initial charging of the battery.

The invention provides a lithium air battery (battery cell) having an electrolyte that is non-volatile, stable in contact with metallic lithium, stable against cathode oxidation during lithium air charging and able to improve the round-trip charge/discharge efficiency. The invention also provides a battery having an electrolyte that contains at least one organosilicon compound, which provides high conductivity, safety, and favorable electrochemical and chemical properties.

### EXAMPLES

The invention will now be described in connection with the following, non-limiting examples. It should be understood, however, that the invention is not limited to the specific details set forth in the example. Parts and percentages set forth herein are by weight unless otherwise specified.

### Example 1

### Production of Air Cathode using PVDF Resin Binder

Cathodes were prepared by milling 3 g KS10 graphite (carbon), 3 g Super P® Li (carbon black, Timcal SA/Timcal AG/Timcal Ltd Corporation of Switzerland), 0.75 g vapor-grown carbon fiber (VGCF) 24 LD carbon fiber (such as the carbon nanofibers manufactured by Pyrograf Products, Inc., an affiliate of Applied Sciences, Inc.), 2.09 g Kynar® PVDF, 1.16 g EMD (electrolytic manganese dioxide, MnO₂), and 70 g ZrO₂ milling media with 130 mL acetone in a ZrO₂ jar at 300 rpm for 17.5 hours in a planetary mill. The milling media was removed by passing the resulting slurry through a wire screen. Cathodes were cast by spreading the slurry at a depth of 20 mil wet thickness onto a 19 cm×39 cm sheet of 0.2 oz/yd² (6.8 g/m²) non-woven carbon veil. The cathodes were allowed to dry under a cover with a ¼″ wide slot down the center, and cut into individual cathodes using a punch. The cathodes were then weighed and a group having a narrow mass range was selected to minimize variation due to the cathode during observation and testing.

### Example 2

### Production of Air Cathode using PTFE Resin Binder

An air cathode was prepared using a fluoropolymer resin binder as a negatively charged, hydrophobic colloid, containing approximately 60% (by total weight) of 0.05 to 0.5 μm polytetrafluoroethylene (PTFE) resin particles suspended in water containing approximately 6% (by weight of PTFE) of a nonionic wetting agent and stabilizer. To produce a Teflon®-bonded cell, a Calgon™ carbon (activated carbon, Calgon Carbon Corporation)-based air cathode was prepared by first wetting 14.22 g of Calgon™ carbon (activated carbon), 0.56 g of Acetylene Black (carbon black pigment), and 0.38 g of electrolytic manganese dioxide with a 60 ml mixture of isopropanol and water (1:2 ratio). The electrolytic manganese dioxide is an oxygen-reduction catalyst, optimally provided in a concentration of 1% to 30% by weight; ruthenium oxide, silver, platinum, or iridium could have been used as alternatives.

Next, 2.92 g of Teflon® 30 (60% Teflon® emulsion in water) were added to the above mixture, mixed, and placed in a bottle with ceramic balls to mix overnight on a roller-run jar mill. Alternatively, the slurry could be planetary milled for 6 hours. After mixing, the slurry/paste was dried in an oven at 110° C. for at least 6 hours to evaporate the water and yield a dry, fibrous mixture. The dry mixture was again wetted by a small quantity of water to form a thick paste, which was then spread over a clean glass plate (or polyester sheet). The mixture was kneaded to the desired thickness as it dried on the glass plate. After drying, it was cold pressed on an Adcote™-brand-adhesive-coated aluminum mesh at 4000 psi for 3 minutes. To remove any cracks in the paste, the cathode assembly was passed through stainless steel rollers. The cathode was then cut into smaller pieces such that the active area of the cathode was 2″ by 2″. A small portion of the aluminum mesh was exposed so that it could be used as the cathode current-collector tab.

### Example 3

### Cell Assembly

Cell assembly was performed inside of an argon-filled glove box to reduce or eliminate undesirable effects on the lithium electrode that are caused by water (particularly water vapor, or moisture, in air).

The cathode was wetted by a non-aqueous, organic-solvent based electrolyte including a lithium salt and an alkylene carbonate and/or an alkylene siloxane additive. Specifically, the electrolyte contained lithium hexafluorophosphate dissolved in a mixture of propylene carbonate and dimethyl ether to a 1 molar concentration (1M LiPF₆ in PC:DME). A pressure-sensitive, porous polymeric separator membrane, such as Policell type B38 (product of Policell Technologies, Inc.) was loaded with a non-aqueous, organic-solvent based electrolyte including a lithium salt and an alkylene additive (vinylene carbonate, butylene carbonate, or an alkylene siloxane such as triacetoxyvinylsilane. The electrolyte-loaded separator membrane was placed on the cathode with the shiny side of the membrane facing away from the cathode. Next, thin lithium foil was placed on the shiny side of the wetted separator, and a 1.5 cm by 4 cm strip of copper mesh is placed along one edge of the thin lithium foil (to serve as an anode current-collector tab), away from the aluminum-mesh cathode current-collector tab. Another cathode piece wetted by the electrolyte and covered with a second electrolyte-loaded separator was placed directly on top of the lithium foil and copper-mesh strip. This is an example of a “double-cell assembly,” illustrated schematically in FIG. 3, because there is a single substantially planar anode flanked on either side by a substantially planar cathode. FIG. 3 illustrates the arrangement of a pair of spaced-apart air cathodes 114, each having a separator 125 separating the cathodes 114 from the centrally-disposed, thin lithium foil anode 112. An anode current-collector tab 130 extends from the anode 112. A cathode current-collector tab 134 extends from one of the cathodes 114 and a cathode current-collector connector 136 connects the current collector portions of the cathodes 114.

The double-cell assembly was laminated on a hot press at 100° C. and 500 lb pressure for 30 to 40 seconds. After the sample was withdrawn from the press, the heat-activated separator bound the sample together.

### Example 4

### Production of Completed, Enclosed Cells

Completed, enclosed cells were produced comprising a cell assembly placed in an enclosure with an electrolyte and then activated for use. The cell assembly comprises the cathode-anode-separator assembly, such as the double-cell assembly described above. Although the example described above is based upon a double cell, the teachings of the invention are equally applicable to a single-cell configuration or a multiple-cell configuration other than the single anode-dual cathode configuration described. The completed cells were also assembled in a glove box to isolate the components.

Various samples of completed cells were prepared for testing, in which the liquid electrolyte employed contained no additive or one of two general types of additives: (a) 2% by weight VS (triacetoxyvinylsilane, a polymerizable silane according to the invention) or (b) 5% by weight VC (vinylene carbonate, an alkylene carbonate additive).

Liquid electrolytes used for testing were 1 M solutions of lithium trifluoromethanesulfonimide (LiTFSI) or lithium hexafluorophosphate (LiPF₆). The lithium salts were used in solvent mixtures containing a 1:2 (w:w) ratio of propylene carbonate and tetraglyme (PC:Tetraglyme) or a 1:2 (w:w) ratio of propylene carbonate and 1,2-dimethoxyethane (PC:DME). Cells constructed in accordance with the teachings of the invention were sealed in an enclosure wherein oxygen or air was injected to a predetermined pressure, preferably about 0.1 atm to about 100 atm, and more preferably about 0.5 atm to about 20 atm.

### Example 5

### Testing of Inventive and Comparative Cells

Embodiments of cells incorporating the teachings of the invention and comparative cells were tested to compare their performances. Three performance characteristics were tested: Rest Voltage Before Cycling, Discharge Voltage During Second Cycle, and Charge Voltage During Second Cycle.

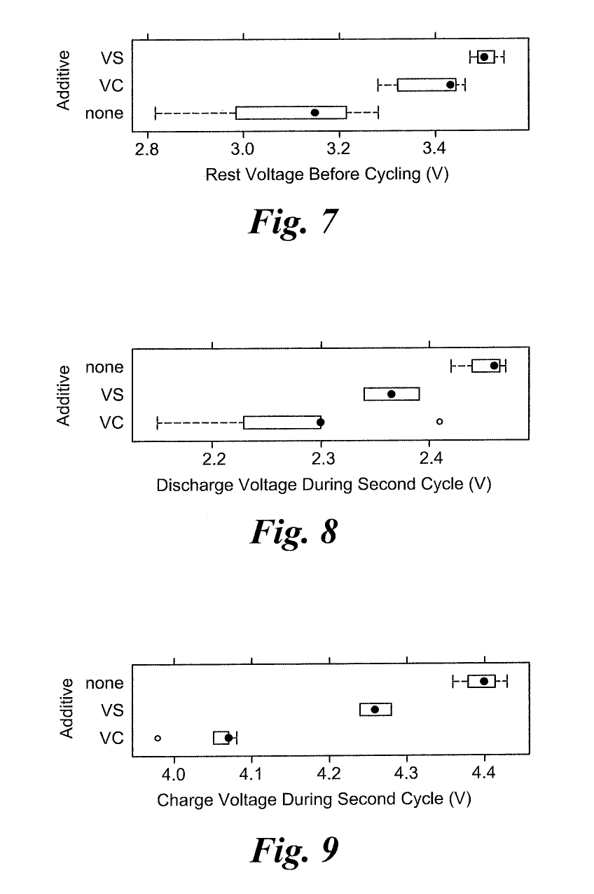

FIGS. 7-9 are box-plot graphs of data recorded for these three characteristics. A “cycle” that is referred to in the testing described herein refers to the period in which a fully-charged cell is discharged to a predetermined level and then re-charged to maximum capacity. Charge to more than 4.6V will enhance the desired decomposition of Li₂O₂. Suitable voltage ranges for charging and discharging are 4 to 4.8V for charging and 3 to 1.5V for discharging. Increasing charging voltage significantly increases the reversibility of the battery.

The results of testing were compared and analyzed utilizing the statistics methodology known as Analysis of Variance (ANOVA). Measurements taken during the second cycle exhibited differences that were considered to be statistically significant and have been described herein.

Referring to FIG. 7, therein is shown a box-plot graph of rest voltage, in volts (V), before cycling for cells tested. The rest voltage (V) for each cell was recorded at the end of the initial rest (or “pre-charging” period, prior to the first discharge). Cells containing the VS additive and the VC additive showed increases in rest voltage relative to the non-additive cells, which increases are statistically significant by ANOVA. Although the rest voltage for the VS sample appears higher than for VC in the box plot of FIG. 7, review using ANOVA principals indicates that they are statistically indistinguishable.

Referring now to FIG. 8, therein is shown a box-plot graph of discharge voltage (V) during the second cycle. This is a representation of the average voltage discharged or dissipated in the second cycle. Battery cells that did not contain an additive according to the present invention gave a statistically higher voltage than cells containing the VC additive according to the invention. However, discharge voltage for cell embodiments containing the VS additive according to the invention were indistinguishable from discharge voltage for cells containing no additive and the discharge voltage for cell embodiments containing the VC additive according to the invention was indistinguishable from the discharge voltage for cells containing the VS additive according to the invention.

Referring now to FIG. 9, therein is shown a box-plot graph comparing charge voltage (V) during a second cycle, that is, the voltage (V) that was required to fully charge the cells. The charge voltage for the second cycle was lowest for cell embodiments containing VC additive, second lowest for cell embodiments containing VS additive, and highest for cells containing no additive.

When the VS additive was utilized in combination with a nonvolatile, liquid electrolyte such as 1 M LiTFSI in 2:1 (PC):tetraglyme, the VS additive served to increase the round-trip efficiency by reducing the charge voltage. Round-trip efficiency is a tool that may be used to compare the effectiveness of one rechargeable cell to another. Round-trip efficiency may be described as a ratio of the total discharge energy E_{dis} (watt-hours) that is dissipated by a cell during a cycle as compared to the total energy E_{ch} (watt hours) required to be applied to fully re-charge a cell after discharge during a cycle. The relationship may be described mathematically as follows:

$$Round \text{-} Trip Efficiency , {e}_{rt , n} = \frac{( 100 ) {E}_{dis , n}}{{E}_{ch , n - 1}} \%$$

wherein
n=cycle number
E_{dis}=Total energy discharged during the cycle “n.”
E_{ch}=Total energy that is applied to re-charge a battery cell at the end of the preceding cycle, that is “n−1.”

As noted above, Round-Trip Efficiency is expressed as a percentage (%).

The invention provides a cell that requires a lesser amount of charge energy E_{ch}, thus increasing the round-trip efficiency.

### Comparative Example 1

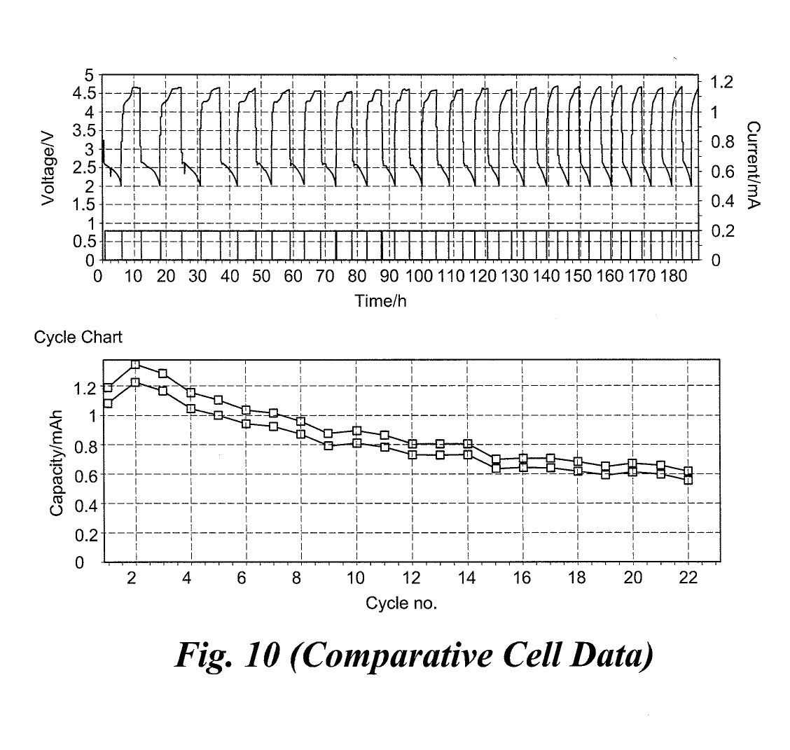

For testing, a standard carbon based cathode was coupled to lithium metal anode via a porous propylene separator (Celgard) to form a lithium/oxygen battery. The electrolyte solution was comprised of propylene carbonate (PC) and tetraglyme in a specific ratio with LITFSI at one molar. As shown in FIG. 10, the cell showed a symmetric charge/discharge voltage vs. time profile, indicating reversibility. However, over the course of 20 cycles, the fade rate of this cell was near 50% per 20 cycles. Upon disassembly of the battery, the cell components and both electrodes appeared to be intact, which indicated that the fading mechanisms were related to the electrolyte solution.

### Example 6

### Preparation and Testing of Inventive Cell Containing PEO-Silane Electrolyte

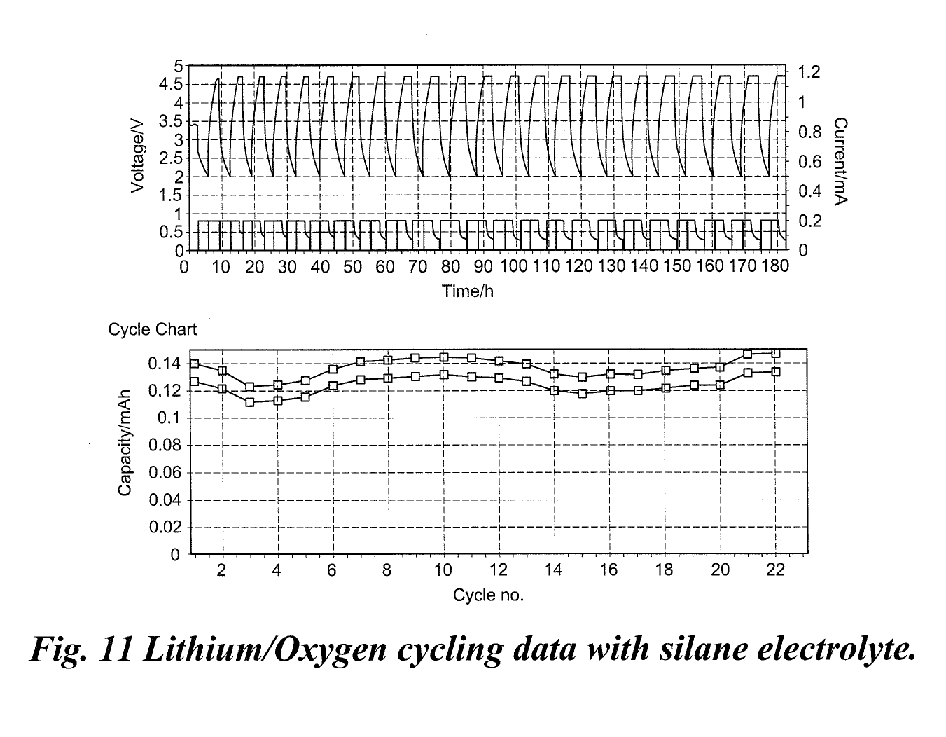

A battery cell was prepared in which an air cathode was cycled versus lithium metal anode using an electrolyte containing an organosilicon compound having Formula (1) in which n=2 (obtained from Argonne National Labs, IL.) The electrolyte was composed of LiTFSI salt dissolved in 1NM2 organosilicon solvent to 1 molar. The cycling data was recorded on a Maccor battery tester and is presented in FIG. 11. Virtually no observable fading occurred over the first 20 cycles. Without wishing to be bound by theory, it is believed that this stability is due to the stability of the silane solvent from nucleophilic attack by the superoxide anion. The superoxide anion is present in the cell because it participates in charge and discharge electrochemical reaction in Li—O₂ cells. In the case of PC based electrolyte solvents, the superoxide anion nucleophilically attacks ethereal carbon in PC leading to its decomposition. The effect is especially pronounced at higher cell voltages.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A rechargeable lithium air battery comprising:
a lithium based anode, an air cathode, and a non-aqueous electrolyte,
wherein the electrolyte comprises a lithium salt and at least one organosilicon compound, and wherein the anode and the cathode are spaced apart from one another and electrochemically coupled to one another by the electrolyte.

2. The rechargeable battery according to claim 1, wherein the lithium salt is selected from the group consisting of lithium hexafluorophosphate, lithium tetrafluoroborate, lithium hexafluoroarsenate, lithium perchlorate, lithium bis(trifluorosulfonyl)imide, lithium bis(perfluoroethylsulfonyl)imide, lithium triflate, lithium bis(oxalato)borate, lithium tris(pentafluoroethyl)trifluorophosphate, lithium bromide, and lithium iodide.

3. The rechargeable battery according to claim 1, wherein the lithium based anode comprises at least one of lithium metal, a lithium-metal based alloy, a lithium-intercalation compound, and lithium titanate.

4. The rechargeable battery according to claim 3, wherein the lithium-intercalation compound comprises at least one of graphite, mesocarbon microbead (MCMB) carbon, and soft carbon.

5. The rechargeable battery according to claim 1, wherein the air cathode is porous.

6. The rechargeable battery according to claim 5, wherein the air cathode comprises a carbon-based, porous electrode and the non-aqueous electrolyte comprising the lithium salt and the at least one organosilicon compound.

7. The rechargeable battery according to claim 6, wherein the lithium salt is selected from the group consisting of lithium hexafluorophosphate, lithium tetrafluoroborate, lithium hexafluoroarsenate, lithium perchlorate, lithium bis(trifluorosulfonyl)imide, lithium bis(perfluoroethylsulfonyl)imide, lithium triflate, lithium bis(oxalato)borate, lithium tris(pentafluoroethyl)trifluorophosphate, lithium bromide, and lithium iodide.

8. The rechargeable battery according to claim 1, wherein the air cathode comprises an oxygen-reduction catalyst.

9. The rechargeable battery according to claim 8, wherein the oxygen-reduction catalyst is selected from the group consisting of electrolytic manganese (IV) dioxide, ruthenium (IV) oxide, copper (II) oxide, copper (II) hydroxide, iron (II) oxide, iron (II,III) oxide, cobalt (II,III) oxide, nickel (II) oxide, silver, platinum and iridium.

10. The rechargeable battery according to claim 1, wherein the at least one organosilicon compound is a silane having at least one polyethyleneoxide side chain.

11. The rechargeable battery according to claim 10, wherein the silane has formula (1), wherein n is an integer of 1 to 20:

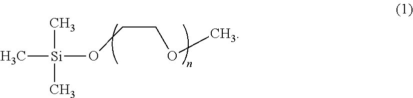

12. The rechargeable battery according to claim 1, wherein the oxygen is a component of air.

13. The rechargeable battery according to claim 6, wherein the at least one organosilicon compound is a silane having at least one polyethyleneoxide side chain.

14. The rechargeable battery according to claim 13, wherein the silane has formula (1), wherein n is an integer of 1 to 20:

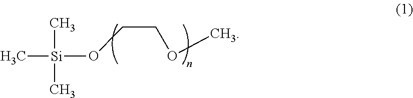

15. A cathode for a rechargeable lithium air battery, wherein the cathode comprises a carbon-based, porous electrode and a non-aqueous electrolyte comprising a lithium salt and at least one organosilicon compound.

16. The cathode according to claim 15, wherein the at least one organosilicon compound is a silane having at least one polyethyleneoxide side chain.

17. The cathode according to claim 16, wherein the silane has formula (1), wherein n is an integer of 1 to 20:

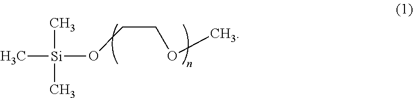

18. The cathode according to claim 15, further comprising an oxygen-reduction catalyst.

19. The cathode according to claim 18, wherein the oxygen-reduction catalyst is selected from the group consisting of electrolytic manganese (IV) dioxide, ruthenium (IV) oxide, copper (II) oxide, copper (II) hydroxide, iron (II) oxide, iron (II,III) oxide, cobalt (II,III) oxide, nickel (II) oxide, silver, platinum and iridium.

20. The cathode according to claim 15, further comprising lithium peroxide.
